(19) United States
(12) Patent Application Publication
(10) Pub. No.: US 2011/0306442 A1
(43) Pub. Date: Dec. 15, 2011

(54) Ionomer Compositions with Good Scuff Resistance

(75) Inventor: JOHN CHU CHEN, Hockessin, DE (US)

(73) Assignee: E.I. DU PONT DE NEMOURS AND COMPANY, Wilmington, DE (US)

(21) Appl. No.: 12/815,566

(22) Filed: Jun. 15, 2010

(51) Int. Cl. A63B 37/06; B29C 53/00; B29C 43/00; B32B 1/08; C08L 33/02; B29C 45/00

(52) U.S. Cl. 473/374; 525/221; 264/328.14; 264/331.17; 428/36.9; 156/217

(57) ABSTRACT

Provided is a composition comprising a mixture of a high molecular weight (Mw between 80,000 and 500,000 Da) carboxylate functionalized ethylene terpolymer, a high molecular weight (Mw between 80,000 and 500,000 Da) carboxylate functionalized ethylene dipolymer and a low molecular weight (Mw between 2,000 and 30,000 Da) carboxylate functionalized ethylene copolymer wherein the carboxylic acid groups are at least partially neutralized to form salts containing zinc cations. The composition provides a good balance of hardness, flexural modulus and scuff resistance. The composition is used in films, multilayer structures and other articles of manufacture, such as golf balls.

### BACKGROUND OF THE INVENTION

1. Field of the Invention

This invention relates to ionomer compositions that have good scuff resistance. In particular, the compositions comprise three ionomers of defined molecular weights. The three ionomers, in turn, comprise cations that are primarily zinc cations.

2. Description of Related Art

Several patents, patent applications and publications are cited in this description in order to more fully describe the state of the art to which this invention pertains. The entire disclosure of each of these patents, patent applications and publications is incorporated by reference herein.

Thermoplastic polymers are commonly used to manufacture various shaped articles that may be utilized in applications such as automotive parts, food containers, signs, packaging materials and sporting goods such as golf balls. Shaped articles may be prepared from the molten thermoplastic polymer by a number of melt processes known in the art, such as injection molding, compression molding, blow molding, and profile extrusion.

Ionomeric resins (ionomers) are useful materials for the construction of golf balls and other articles. Ionomers are ionic copolymers that are obtained by copolymerization of an olefin such as ethylene with an unsaturated carboxylic acid such as acrylic acid (AA), methacrylic acid (MAA), or maleic acid. Optionally, one or more softening monomers, such as alkyl acrylates, may be included in the olefin acid copolymer. At least a portion of the carboxylic acid groups in the copolymer are neutralized with a neutralizing agent, such as a base, to form carboxylate groups having counter cations, such as for example zinc cations or sodium cations. The resulting ionomer is a thermoplastic resin exhibiting favorable properties for use in golf balls.

For example, golf balls constructed using ionomeric materials have improved resilience and durability as compared with golf balls constructed with balata. As a result of their resilience, toughness, durability and good flight characteristics, ionomers have become materials of choice for the construction of golf balls over the traditional balata, trans-polyisoprene, natural and synthetic rubbers.

In attempts to produce a durable, high spin ionomeric golf ball, harder ionomeric resins have been blended with softer ionomeric resins. U.S. Pat. Nos. 4,884,814 and 5,120,791, for example, are directed to cover compositions containing blends of hard and soft ionomeric resins. The hard copolymers typically are ionomers of dipolymers made from an olefin and an unsaturated carboxylic acid and soft copolymers typically are ionomers of terpolymers made from an olefin, an unsaturated carboxylic acid and an unsaturated carboxylic acid ester. While golf balls formed from hard-soft ionomer blends have good cut resistance, they tend to become scuffed more readily than covers made of hard ionomer alone. U.S. Pat. No. 5,902,855 is directed to golf balls with scuff resistant covers comprising blends of ionomers with Shore D hardness of about 40 to 64 units.

Bimodal ionomer compositions and their use in golf balls are described in U.S. Pat. Nos. 6,562,906; 6,762,246; 7,037,967; 7,273,903 and 7,488,778 and in U.S. patent application Ser. No. 12/315,731. The bimodal ionomer compositions may also be used as scratch and scuff-resistant surface layers of a variety of articles (U.S. Patent Application Publication No. 2009/0130355). These compositions comprise an ethylene α,β-ethylenically unsaturated C₃₋₈ carboxylic acid copolymer having weight average molecular weight (Mw) of about 80,000 to about 500,000 Da (high molecular weight copolymer) and an ethylene α,β-ethylenically unsaturated C₃₋₈ carboxylic acid copolymer having (Mw) of about 2,000 to about 30,000 Da (low copolymer). In some cases, however, these bimodal compositions are too soft to be desirable for use as golf ball covers.

The golfing industry has also developed golf ball covers formed from polyurethane compositions. These covers combine good scuff resistance and a softness that enables spin control and good playability. Because of this combination of desirable factors, golf balls with polyurethane covers are considered to be “premium” balls for the more skilled player. Polyurethane covers are low in resilience, however, and hence detract from the performance of the golf ball. In addition, thermoset polyurethane covers are more difficult to process than thermoplastic ionomer resins. The material costs are higher, as well, and therefore golf balls with polyurethane covers also more expensive to manufacture.

Thus, it would be useful to develop a golf ball cover material having a desirable combination of softness, resilience, heat stability, melt processibility and lower cost with good scuff resistance. It is also desirable to develop a golf ball having a favorable combination of playability and durability.

### SUMMARY OF THE INVENTION

Provided herein is a composition comprising, consisting essentially of, consisting of, or prepared from

(a) 15 to 80 weight %, based on the combination of (a), (b) and (c), of an E/X/Y terpolymer, wherein E represents copolymerized units of ethylene, X represents copolymerized units of a C₃ to C₈ α,β-ethylenically unsaturated carboxylic acid, and Y represents copolymerized units of a softening comonomer selected from the group consisting of vinyl acetate, alkyl acrylate and alkyl methacrylate; wherein the alkyl groups have from 1 to 8 carbon atoms; wherein the amount of X is from about 2 to about 30 weight % of the E/X/Y terpolymer, and the amount of Y is from about 3 to about 45 weight % of the E/X/Y terpolymer; and wherein the weight average molecular weight (Mw) of the E/X/Y terpolymer is in the range of 80,000 to 500,000 Da;

(b) 5 to 80 weight %, based on the combination of (a), (b) and (c), of an E/W dipolymer wherein E represents copolymerized units of ethylene and W represents copolymerized units of acrylic acid or methacrylic acid, wherein the amount of W is about 3 to about 12 weight % of the E/W dipolymer and wherein the Mw of the E/W dipolymer is in the range of 80,000 to 500,000 Da; and

(c) 2 to 20 weight %, based on the combination of (a), (b) and (c), of an E/Z dipolymer, wherein E represents copolymerized units of ethylene and Z represents copolymerized units of acrylic acid or methacrylic acid; wherein the amount of Z is about 3 to about 25 weight % of the E/Z copolymer; and wherein the Mw of the E/Z dipolymer in the range of 2,000 to 30,000 Da;

and further wherein at least 30% of the combined carboxylic acid groups in the E/X/Y terpolymer, the E/W dipolymer and the E/Z dipolymer are nominally neutralized to form carboxylate salts comprising a preponderance of zinc cations.

This composition has Shore D hardness of 35 to 55 (measured in accordance with ASTM D-2240 on a standard test plaque) and flex modulus of 9 to 50 kpsi (measured in accordance with ASTM D-790B), with very good scuff resistance, characterized by a weight loss of less than 5 mg per hit (preferably less than 3 mg/hit) when spheres of the composition are struck by a simulated golf club.

Also provided is a method for increasing the hardness and flex modulus and retaining scuff resistance of a first ionomer composition, the method comprising melt mixing the first ionomer composition with a second ionomer composition to provide a third ionomer composition;

wherein the first ionomer composition comprises, consists essentially of, or is prepared from

(i) 70 to 95 weight %, based on the total weight of (i) and (ii), of an E/X/Y terpolymer, wherein E represents copolymerized units of ethylene, X represents copolymerized units of a C₃ to C₈ α,β-ethylenically unsaturated carboxylic acid, and Y represents copolymerized units of a softening comonomer selected from the group consisting of vinyl acetate, alkyl acrylate and alkyl methacrylate, wherein the alkyl groups have from 1 to 8 carbon atoms, wherein the amount of X is from about 2 to about 30 weight % of the E/X/Y terpolymer, and the amount of Y is from 3 to about 45 weight % of the E/X/Y terpolymer, and wherein the weight average molecular weight (Mw) of the E/X/Y terpolymer is in the range of 80,000 to 500,000 Da; and

(ii) 5 to 30 weight %, based on the total weight of (i) and (ii), of an E/Z copolymer, wherein E represents copolymerized units of ethylene and Z represents copolymerized units of acrylic acid or methacrylic acid, wherein the amount of Z is about 3 to about 25 weight % of the E/Z copolymer and wherein the Mw of the E/Z copolymer is in the range of 2,000 to 30,000 Da; wherein at least 30% of the combined carboxylic acid groups in the E/X/Y terpolymer and the E/Z copolymer are nominally neutralized to form carboxylate salts comprising zinc cations;

and the second ionomer composition comprises an E/W dipolymer wherein E represents copolymerized units of ethylene and W represents copolymerized units of acrylic acid or methacrylic acid, wherein the amount of W is about 2 to about 12 weight % of the E/W dipolymer, and wherein the Mw of the E/W dipolymer is in the range of 80,000 to 500,000 Da, wherein at least 35% of the carboxylic acid groups in the E/W dipolymer are nominally neutralized to form carboxylate salts;

to provide a third ionomer composition comprising 5 to 80 weight % of the second ionomer composition, based on the total weight of (i), (ii) and second ionomer composition, wherein the third ionomer composition has Shore D hardness of 35 to 55, flex modulus of 9 to 50 kpsi and scuff resistance characterized by weight loss of less than 5 mg per hit (preferably less than 3 mg/hit) when spheres of the composition are struck by a simulated golf club.

Further provided are articles prepared from the bimodal ionomer composition or using the method described above.

### DETAILED DESCRIPTION OF THE INVENTION

The following definitions apply to terms used in this specification, unless otherwise limited in specific instances. The technical and scientific terms used herein have the meanings that are commonly understood by one of ordinary skill in the art to which this invention belongs. In case of conflict, the present specification, including the definitions herein, will control.

As used herein, the terms “comprises,” “comprising,” “includes,” “including,” “containing,” “characterized by,” “has,” “having” or any other variation thereof, refer to a non-exclusive inclusion. For example, a process, method, article, or apparatus that comprises a given list of elements is not necessarily limited to only those elements given, but may further include other elements not expressly listed or inherent to such process, method, article, or apparatus.

The transitional phrase “consisting of” excludes any element, step, or ingredient not specified in the given list of elements, closing the list to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A ‘consisting essentially of’ claim occupies a middle ground between closed claims that are written in a ‘consisting of’ format and fully open claims that are drafted in a ‘comprising’ format. Optional additives as defined herein, at levels that are appropriate for such additives, and minor impurities are not excluded from a composition by the term “consisting essentially of”.

The basic and novel characteristics of this invention are a desirable balance of hardness, flex modulus and low weight loss when struck by a simulated golf club.

When a composition, a process, a structure, or a portion of a composition, a process, or a structure, is described herein using an open-ended term such as “comprising,” unless otherwise stated the description also includes an embodiment that “consists essentially of” or “consists of” the elements of the composition, the process, the structure, or the portion of the composition, the process, or the structure.

The articles “a” and “an” may be employed in connection with various elements and components of compositions, processes or structures described herein. This is merely for convenience and to give a general sense of the compositions, processes or structures. Such a description includes “one or at least one” of the elements or components.

Moreover, as used herein, the singular articles also include a description of a plurality of elements or components, unless it is apparent from a specific context that the plural is excluded.

The term “or”, as used herein, is inclusive; that is, the phrase “A or B” means “A, B, or both A and B”. More specifically, a condition “A or B” is satisfied by any one of the following: A is true (or present) and B is false (or not present); A is false (or not present) and B is true (or present); or both A and B are true (or present). Exclusive “or” is designated herein by terms such as “either A or B” and “one of A or B”, for example.

The term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The ranges set forth herein include their endpoints unless expressly stated otherwise. When an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. The scope of the invention is not limited to the specific values recited when defining a range.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may become recognized in the art as suitable for a similar purpose.

Unless stated otherwise, all percentages, parts, ratios, and like amounts, are defined by weight.

As used herein, the term “copolymer” refers to polymers comprising copolymerized units resulting from copolymerization of two, or two or more comonomers. In this connection, a copolymer may be described herein with reference to its constituent comonomers or to the amounts of its constituent comonomers, for example “a copolymer comprising ethylene and 9 weight % of acrylic acid”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such. The term “dipolymer” refers to polymers consisting essentially of two monomers and the term “terpolymer” refers to polymers consisting essentially of three monomers.

The term “Mw” means weight average molecular weight and the term “Mn” means number average molecular weight. The terms “low molecular weight copolymer” or “low molecular weight dipolymer” as used herein refer to polymers that have a molecular weight (Mw) in the range of 2,000 to 30,000 Da. The terms “high molecular weight copolymer” “high molecular weight terpolymer”, and “high molecular weight dipolymer” as used herein refer to polymers that have a molecular weight (Mw) in the range of 80,000 to 500,000 Da. “Bimodal ionomer” or “BMI” refers to a mixture of a high molecular weight copolymer and a low molecular weight copolymer wherein the Mw of the high molecular weight copolymer and the Mw of the low molecular weight copolymer are sufficiently different such that two distinct molecular weight peaks are observed when measuring the Mw of the blend by gel permeation chromatography (GPC) with a high resolution column, wherein the combined acid moieties of the high molecular weight copolymer and the low molecular weight copolymer are at least partially neutralized to form carboxylate salts.

The term “trimodal ionomer” as used herein refers to a mixture of a high molecular weight terpolymer, a high molecular weight dipolymer and a low molecular weight dipolymer in which at least a portion of the combined carboxylate groups are neutralized to salts. Importantly, the molecular weights (Mw) of the high molecular weight dipolymer and the high molecular weight terpolymer in the trimodal compositions may be the same or different provided the molecular weight of each falls within the range of 80,000 to 500,000 Da. Also significantly, the comonomer compositions of the high and low molecular weight copolymers in each bimodal or trimodal composition may be the same or different.

The term “melt index” or “MI” refers to melt index as determined according to ASTM D1238 at 190° C. using a 2160 g weight, with values of MI reported in g/10 minutes, unless otherwise specified.

Finally, in abbreviated descriptions of copolymers, “E” stands for copolymerized ethylene, “MAA” stands for copolymerized methacrylic acid, “AA” stands for copolymerized acrylic acid and “nBA” stands for copolymerized n-butyl acrylate, and the numbers indicate the weight % of the copolymerized comonomer present in the copolymer. For example, “E/9MAA/23.5nBA” refers to a terpolymer comprising 9 wt % of copolymerized residues of methacrylic acid, 23.5 wt % of copolymerized residues of n-butyl acrylate, and the remainder (100 wt %-23.5 wt %-9 wt %=67.5 wt %) of copolymerized residues of ethylene.

Bimodal ionomer compositions are useful as thermoplastic compositions for molding applications, including covers for golf balls. Surprisingly, by proper selection of the components and neutralizing counterions, adding another ionomer to a bimodal ionomer composition provides a trimodal ionomer with a combination of scuff resistance, hardness, and flex modulus that is superior to the properties of the original bimodal ionomer composition or to those of the other ionomer. For example, blending a zinc-containing BMI (e.g., a mixture of an E/AA/nBA high molecular weight terpolymer and an E/AA low molecular weight copolymer, the composition having zinc carboxylate salts) with a high molecular weight E/MAA dipolymer with 12 weight % of MAA or less, or preferably with its zinc-containing ionomer, provides a composition with excellent scuff resistance and desirable hardness and flex modulus.

### High Molecular Weight Copolymers

The high molecular weight copolymer components of the bimodal and trimodal ionomer compositions are preferably ‘direct’ acid copolymers or random acid copolymers, in which the comonomers are copolymerized to form a polymer backbone, as opposed to grafted copolymers in which a comonomer is added onto an existing polymer backbone. The high molecular weight copolymers have a molecular weight (Mw) of about 80,000 to about 500,000 Da. Preferably, they have a polydispersity (Mw/Mn) of about 1 to about 15, more preferably about 1 to about 10.

The high molecular weight copolymers are copolymers of an α-olefin, preferably ethylene, with an α,β-ethylenically unsaturated carboxylic acid, preferably acrylic acid or methacrylic acid, optionally containing a third softening monomer depending on whether dipolymers or terpolymers are desired. “Softening” means that the inclusion of the comonomer lowers the crystallinity of the terpolymer compared to that of an acid-only dipolymer.

Thus, high molecular weight terpolymers may be described as E/X/Y terpolymers wherein E represents copolymerized units of ethylene, X represents copolymerized units of a C₃₋₈ α,β-ethylenically unsaturated carboxylic acid, and Y represents copolymerized units of a softening comonomer selected from alkyl acrylate and alkyl methacrylate, wherein the alkyl groups have from 1 to 8 carbon atoms, and vinyl acetate.

X is present in an amount of about 2 to about 30 (or about 2 to 25 or about 2 to 20, preferably 5 to 25, more preferably 5 to 20, or 5 to 10) weight %, based on the total weight of the E/X/Y polymer. Y is present in an amount of from 3 to 45 weight %, preferably from a lower limit of 3 or 5 or more preferably 10, to an upper limit of 25, 30 or 45 weight %, again based on the total weight of the E/X/Y terpolymer. Of note are E/X/Y terpolymers in which X represents copolymerized units of acrylic acid and Y represents copolymerized units of an alkyl acrylate. Suitable terpolymers include without limitation ethylene/acrylic acid/methyl acrylate, ethylene/acrylic acid/ethyl acrylate, ethylene/acrylic acid/n-butyl acrylate, ethylene/acrylic acid/iso-butyl acrylate. Preferred terpolymers include ethylene/acrylic acid/n-butyl acrylate terpolymers.

Also of note are E/X/Y terpolymers in which X represents copolymerized units of methacrylic acid and Y represents copolymerized units of an alkyl acrylate. These terpolymers include without limitation ethylene/methacrylic acid/methyl acrylate, ethylene/methacrylic acid/ethyl acrylate, ethylene/methacrylic acid/n-butyl acrylate, and ethylene/methacrylic acid/iso-butyl acrylate, notably ethylene/methacrylic acid/n-butyl acrylate terpolymers.

High molecular weight dipolymers may be described as E/W dipolymers, including without limitation, ethylene/acrylic acid dipolymers and preferably ethylene/methacrylic acid dipolymers. Thus, W represents copolymerized residues of acrylic acid or methacrylic acid. The amount of W is 12 weight % or less, based on the weight of the E/W copolymer.

The high molecular weight copolymers preferably have melt indices (MI) from about 0.1 to about 600, or from about 25 to about 300, or from about 60 to about 250 g/10 min.

Methods of preparing ethylene acid copolymers, such as E/X/Y and E/W, are known. For example, ethylene acid copolymers may be prepared in continuous polymerizers by use of “co-solvent technology” as described in U.S. Pat. No. 5,028,674.

Suitable high molecular weight copolymers are commercially available from E. I. DuPont de Nemours & Company of Wilmington, Del., under the trademark “Surlyn®” and from the ExxonMobil Chemical Corporation of Houston, Tex., under the tradenames “Escor” and “Iotek”.

Examples of suitable high molecular weight copolymers and their molecular weights are shown in Table A. “NA” means not available. HC-1 through HC-7 are examples of terpolymers, including E/X/Y terpolymers. HC-8 through HC-17 are examples of E/W dipolymers in which the amount of W is 12 weight % or less.

TABLE A

| | | | | | Polydis- |
|---|---|---|---|---|---|
| | Polymer | | | | persity |
| | Composition | MI | Mn (10³) | Mw (10³) | (Mw/Mn) |
| HC-1 | E/9MAA/23.5nBA | 25 | 26.6 | 176.5 | 6.6 |
| HC-2 | E/8.3AA/17nBA | NA | NA | NA | NA |
| HC-3 | E/6.2AA/28nBA | 200 | NA | NA | NA |
| HC-4 | E/10.5AA/15.5nBA | 60 | NA | NA | NA |
| HC-5 | E/8.5AA/15.5nBA | 60 | NA | NA | NA |
| HC-6 | E/10MAA/17nBA | 25 | NA | NA | NA |
| HC-7 | E/15AA/35nBA | 200 | NA | NA | NA |
| HC-8 | E/15MAA | 60 | 17.6 | 112.4 | 6.4 |
| HC-9 | E/4MAA | 3 | 31.7 | 365.5 | 11.5 |
| HC-10 | E/9MAA | 2.5 | NA | NA | NA |
| HC-11 | E/10MAA | 450 | NA | NA | NA |
| HC-12 | E/10MAA | 500 | 16.0 | 84.0 | 5.3 |
| HC-13 | E/10MAA | 35 | 19.6 | 160.8 | 8.2 |
| HC-14 | E/19MAA | 60 | NA | NA | NA |
| HC-15 | E/11MAA | 95 | NA | NA | NA |
| HC-16 | E/15MAA | 220 | NA | NA | NA |
| HC-17 | E/8.7MAA | 10 | NA | NA | NA |

### Low Molecular Weight Copolymers

The low molecular weight copolymers are preferably ‘direct’ acid copolymers or random acid copolymers having a molecular weight (Mw) of about 2,000 to about 30,000 Da. Preferably they have polydispersities (Mw/Mn) of about 1 to about 10, more preferably about 1 to about 6. They are copolymers of an α-olefin, preferably ethylene, with a C₃₋₈ α,β-ethylenically unsaturated carboxylic acid, preferably acrylic or methacrylic acid. Also preferably, the amount of copolymerized acid residues in these copolymers is about 3 to about 30 (or 5 to 20, or 3 to 15, most preferably 5 to 10) weight %, based on the total weight of the low molecular weight copolymer. When the α-olefin is ethylene, the low molecular weight acid copolymers may be referred to as “E/Z” copolymers. In this abbreviation, E once more represents copolymerized residues of ethylene, and Z represents copolymerized residues of the α,β-ethylenically unsaturated carboxylic acid.

These low molecular weight copolymers also may be referred to as acid copolymer waxes. Suitable examples are commercially available from Honeywell Specialty Wax and Additives of Morristown, N.J. (e.g., AC 540, believed to be an ethylene/5 weight % acrylic acid copolymer with a number average molecular weight of 4369, and others indicated in Table B with their molecular weights).

These low molecular weight polymers are typically too low in viscosity at elevated temperatures to have a meaningful or measurable melt index. Instead, their Mw may be correlated to their Brookfield viscosity. This technique for measuring viscosity of fluids is outlined in, for example, ASTM D2196, D2983 or D3236-1978. The Brookfield viscosity is reported in centipoise and the value is determined by the type of spindle and the spindle speed or shear rate at which the Brookfield Viscometer is operated. Brookfield Viscosity data (measured at 140° C.) in Table B were provided by Honeywell or by its predecessor, the Allied Signal Corporation.

TABLE B

| | | | Brookfield | | | Poly- |
|---|---|---|---|---|---|---|
| | Trade | | Viscosity | Mn | Mw | dispersity |
| | Designation | Composition | (cps) | (10³) | (10³) | (Mw/Mn) |
| LC-1 | AC143 | E/17AA | NA | NA | 2.04 | NA |
| LC-2 | AC540 | E/5AA | 575 | 4.3 | 7.5 | 1.7 |
| LC-3 | AC580 | E/10AA | 650 | 4.8 | 26.0 | 5.4 |
| LC-4 | AC5120 | E/15AA | 650 | 3.0 | 5.2 | 1.7 |

Preferably the Mw of the high molecular weight copolymers is separated from the Mw of the low molecular weight copolymers sufficiently that the peaks for the high molecular weight copolymers are distinctly separated from the peaks for the low molecular weight copolymers when the molecular weight distribution of the mixture is determined by GPC with a high resolution column. Preferably, high molecular weight copolymers with lower Mw are blended with low molecular weight copolymers with lower Mw (e.g. high molecular weight copolymers with Mw of 80,000 Da with low molecular weight copolymers with Mw of 2,000 Da). This preference becomes less important as the Mw of the high molecular weight copolymer increases.

### Ionomers

Ionomers are acid copolymers in which at least some of the carboxylic acid groups in the copolymer are neutralized to form the corresponding carboxylate salts. Ionomers may be prepared from the high and low molecular weight acid copolymers described above, wherein the carboxylic acid groups present are at least partially neutralized by basic compounds to form salts comprising alkali metal ions, transition metal ions, alkaline earth metal ions, other metal ions or combinations of cations. Methods for preparing ionomers are described in U.S. Pat. No. 3,264,272.

Compounds suitable for neutralizing the acid copolymer include any base of appropriate pKa that is stable under processing conditions. Preferred are ionic compounds having basic anions and alkali metal (group IA) cations (for example, lithium, sodium or potassium ions), alkaline earth (group IIA) metal cations (for example magnesium or calcium ions), transition metal cations (for example silver or copper ions), cations of other metals (for example tin or zinc cations) and mixtures or combinations of such cations. Zinc cations are preferred.

Ionic compounds that may be used for neutralizing the ethylene acid copolymers include metal formates, acetates, nitrates, carbonates, hydrogen carbonates, oxides, hydroxides or alkoxides. The amount of ionic compound capable of neutralizing a certain number of acidic groups (referred to herein as “% nominal neutralization” or “nominally neutralized”) may be determined by simple stoichiometric principles. When an amount of base sufficient to neutralize a target amount of acid moieties in the acid copolymer is made available in a melt blend, it is assumed that, in aggregate, the indicated level of nominal neutralization is achieved.

Ionomers of the high molecular weight copolymers and of the low molecular weight copolymers when made separately may be made by methods described above. The degree of neutralization and the acid level preferably are such that the resulting ionomers of the high molecular weight copolymers and the ionomers of the low molecular weight copolymers are melt processible. Examples of suitable ionomers prepared from high molecular weight copolymers include those in Table C. Preferred are zinc-containing ionomers.

TABLE C

| | Acid | Nominal | | |
|---|---|---|---|---|
| Ionomer | copolymer | Neutralization (%) | Cation | MI |
| I-1 | HC-1 | 51 | Mg | 1.1 |
| I-2 | HC-14 | 37 | Na | 2.6 |
| I-3 | HC-8 | 58 | Zn | 0.7 |
| I-4 | HC-8 | 56 | Mg | 0.75 |
| I-7 | HC-3 | 53 | Zn | 5.0 |
| I-8 | HC-3 | 51 | Na | 4.5 |
| I-9 | HC-16 | 52 | Zn | 4.2 |
| I-10 | HC-15 | 58 | Zn | 5.3 |
| I-11 | HC-16 | 51 | Na | 4.5 |
| I-12 | HC-8 | 56 | Na | 0.93 |
| I-13 | HC-16 | 51 | Li | 2.6 |
| I-14 | HC-17 | 18 | Zn | 5.2 |
| I-15 | HC-13 | 55 | Na | 1.3 |
| I-16 | HC-18 | 68 | Zn | 1.1 |

Preferably in these trimodal ionomer compositions, the high molecular weight copolymers are present in about 40 to about 95 weight %, based on the combined total weight of the high molecular weight copolymers and the low dipolymer. The low dipolymer(s) are present in the range of about 2 to about 20 weight %, or about 5 to about 20 weight %, based on the total weight of the high molecular weight copolymers and the low molecular weight copolymers.

In the trimodal ionomer compositions used herein, at least 30% of the combined acid moieties in the high molecular weight terpolymers and low molecular weight copolymers are neutralized to carboxylate salts comprising zinc cations. Preferably, the combined acid moieties of the high molecular weight terpolymers and low molecular weight copolymers in the bimodal ionomer are partially or fully neutralized to a level of about 40 to about 100%, or about 40 to about 85%, or about 40 to about 75%, or about 50 to about 90%, or about 50 to about 85%, or about 50 to about 75% or about 60 to about 80%, based on the total number of acid moieties in the high and low molecular weight copolymers.

In the scuff resistant compositions, a preponderance of the cations is zinc cations. Preferably, the cations comprise at least about 70 equivalent %, at least about 90 equivalent %, at least about 97%, and more preferably 100 equivalent % of zinc cations, based on the total number of moles of carboxylate moieties (neutralized acid groups) present in the E/X/Y, E/W and E/Z ionomers. Small amounts of other metal cations, such as alkali metal cations, alkaline earth metal cations or transition metal cations, may also be present, provided that a preponderance or a large preponderance of the cations are zinc cations.

The components of the trimodal ionomer composition may be combined by any suitable technique. Preferably the non-neutralized high molecular weight terpolymers and low molecular weight copolymers are melt-blended and neutralized in situ so that desired higher or full neutralization may be achieved in one step. Alternatively, bimodal ionomer compositions may be made by melt blending a melt processible ionomer of a high molecular weight terpolymer made separately (see below) with a low molecular weight copolymer, or ionomer thereof, and then adding an additional high molecular weight dipolymer, optionally further neutralizing to achieve the desired nominal neutralization of the resulting blend.

In either case, neutralization may be effected by treating the high and/or low molecular weight copolymers with a basic compound, preferably containing zinc cations, such as zinc oxide and/or zinc acetate. The basic compound(s) may be added neat to the acid copolymer(s) or ionomer(s) thereof. Alternatively, they may be premixed with a polymeric material, such as an acid copolymer, to form a “masterbatch” that may be added to the acid copolymers or ionomers thereof.

The scuff resistant ionomer composition may also be prepared by mixing the individual components in a different sequence. For example, an E/X/Y zinc ionomer may be blended with a combination of E/Z copolymer and E/W dipolymer and further neutralized with zinc-containing basic compounds. Alternatively, a mixture of E/X/Y and E/W high molecular weight copolymers and a low E/Z dipolymer may be blended and neutralized with zinc-containing basic compounds, either sequentially or concurrently. Other methods of preparation are also envisioned, provided that the resulting ionomer composition is as described above.

For example, in order to provide improved hardness and flex modulus with good scuff resistance, a first bimodal ionomer composition comprising an E/X/Y high molecular weight terpolymer and an E/Z low molecular weight copolymer and having a preponderance of zinc cations may be prepared and subsequently melt blended with a second ionomer, preferably a zinc-containing ionomer prepared from an E/W dipolymer. This method provides a third ionomer composition that has a combination of hardness, flex modulus and scuff resistance that is superior to that of the first bimodal ionomer.

In another example, a zinc-containing bimodal ionomer composition may be melt blended with a second ionomer, such as an ethylene methacrylic acid dipolymer wherein the methacrylic acid is from 2 to 12 weight % of the polymer and at least 35% of the acid moieties are neutralized to carboxylate salts comprising zinc cations.

Of note are bimodal compositions comprising (1) a high molecular weight copolymer component comprising an E/X/Y terpolymer, wherein X (e.g. methacrylic acid or acrylic acid) is from 5 to 20 weight % of the copolymer and Y (e.g. alkyl acrylate such as butyl acrylate) is from 10 to 45 weight % of the copolymer, and (2) the low molecular weight copolymer; wherein at least 30% of the combined acid groups of (1) and (2) are neutralized to zinc salts. Of particular note are E/X/Y terpolymers and ionomer compositions thereof wherein X is acrylic acid and Y is n-butyl acrylate, including a terpolymer with 6.2 weight % of acrylic acid and 28 weight % of n-butyl acrylate. Also of note are E/X/Y terpolymers and ionomer compositions thereof wherein X is methacrylic acid and Y is n-butyl acrylate, including a terpolymer comprising 9 weight % of methacrylic acid and 23 weight % n-butyl acrylate. The resulting trimodal ionomer composition has a combination of scuff resistance, hardness and flex modulus that is superior to that of a bimodal composition consisting essentially of an E/X/Y high molecular weight terpolymer and E/Z low molecular weight dipolymer.

Of note are methods and compositions as described herein wherein no additional polymeric materials other than those listed are included.

The compositions may further comprise small amounts of optional materials commonly used and well known in the polymer art, however. Such materials include conventional additives used in polymeric materials including plasticizers, stabilizers including viscosity stabilizers and hydrolytic stabilizers, primary and secondary antioxidants such as for example IRGANOX™1010, ultraviolet ray absorbers and stabilizers, anti-static agents, dyes, pigments or other coloring agents, fire-retardants, lubricants, processing aids, slip additives, antiblock agents such as silica or talc, release agents, and/or mixtures thereof. Other optional additives include inorganic fillers as described above; TiO₂, which is used as a whitening agent; optical brighteners; surfactants; and other components known in the polymer. Many additives are described in the Kirk Othmer Encyclopedia of Chemical Technology, 5^{th} edition, John Wiley & Sons (Hoboken, 2005).

These conventional ingredients may be present in the compositions in quantities that are generally from 0.01 to 15 weight %, preferably from 0.01 to 5 weight % or 0.01 to 10 weight %, based on the total weight of the composition, so long as they do not detract from the basic and novel characteristics of the composition and do not significantly adversely affect the performance of the material prepared from the composition.

The incorporation of these optional materials into the compositions may be carried out by any known process, for example, by dry blending, by extruding a mixture of the various constituents, by the conventional masterbatch technique, or the like.

After melt mixing the components to prepare the zinc-containing trimodal ionomer composition according to the methods as described above and incorporating the optional materials, if any, the composition may be further processed. In particular, the composition may be further processed in a molten state into a shaped third ionomer composition; and the shaped third ionomer composition may be cooled to provide a shaped article. In some processes, the composition may be melt mixed and further processed into an article that is a finished shaped article. In other processes, the composition may be formed into shaped articles such as, but not limited to, pellets, slugs, rods, ropes, sheets and the like, that may be further transformed by additional processes into other shaped articles. The processing and forming steps may comprise one or more methods selected from the group consisting of extrusion, injection molding (i.e. extrusion of the molten composition into molds, followed by cooling, the molds being in a configuration to produce an article comprising the composition in a desired shape), compression molding, overmolding, profile extrusion, lamination, coextrusion, and extrusion coating. Sheets or films of the composition may be produced by extrusion through a laminar die or annular and processing the composition by, for example, cast sheet or film extrusion, blown film extrusion, extrusion coating or lamination techniques well know in the polymer processing art.

The ionomer composition described herein may be used as an alternative to a previously known bimodal ionomer composition to prepare shaped articles having excellent scuff resistance and desirable hardness and flex modulus.

The ionomer composition described herein may also be used to form multilayer structures in which at least one layer comprises the ionomer composition. Other layers of the multilayer structures may include polymeric materials including thermoset compositions or thermoplastic compositions other than the zinc-containing trimodal ionomer composition. Alternatively, the trimodal ionomer composition may be applied as a surface coating or layer to various substrates. Substrates may be independently selected from the group consisting of thermoplastic films and sheets, cellular foams, woven, knitted and non-woven fabrics, paper, pulp and paperboard products, wood and wood products, metal, glass, stone, ceramic, and leather and leather-like products, thermoplastic resins, and thermoset resins. The ionomer composition may also be a substrate to which other materials are adhered.

Injection molded articles include golf balls in which at least one layer of the golf ball comprises the zinc-containing scuff resistant ionomer composition described herein. A golf ball may be a one-piece golf ball or it may comprise a cover (the outermost layer), a core (the innermost layer) and optionally at least one intermediate layer between the cover and the core. Of note are golf balls in which the cover comprises the zinc-containing trimodal ionomer composition. Alternatively, more than one layer of the golf ball may comprise the trimodal ionomer composition. Preferably, the ionomer composition is present in the cover, in an intermediate layer, or in both the cover and in an intermediate layer of the golf ball. The golf balls may be prepared according to methods described in U.S. Pat. Nos. 6,562,906; 6,762,246 and 7,037,967 and U.S. patent application Ser. No. 11/101,078. Additional details of golf ball construction may be found in U.S. patent application Ser. Nos. 11/789,831 (U.S. Patent Application Publication No. 2007/0203277); 12/215,764 and 12/261,331.

Other shaped articles may comprise or be produced from the composition described herein. These articles include, for example, containers, closures, and films are useful for packaging goods such as foodstuffs, cosmetics, health and personal care products, pharmaceutical products and the like.

Containers include trays, cups, cans, buckets, tubs, boxes, bowls, bottles, vials, jars, tubes, and the like. A container may be useful for packaging liquids such as water, milk, and other beverages. Alternatively, it may contain medicines, pharmaceuticals or personal care products. Other liquids that may be packaged in bottles include foods such as edible oils, syrups, sauces, and purees such as baby foods. Powders, granules and other flowable solids may also be packaged in bottles.

Injection molded hollow articles suitable as bottle preforms are also examples of molded articles. Examples of blow-molded articles include containers such as blown bottles. In the bottle and container industry, the blow molding of injection-molded preforms has gained wide acceptance. An outside layer comprising the ionomer composition provides a soft feel and scuff- or scratch-resistance to bottles.

Injection molding a bottle preform may be conducted by transporting a molten material of the various layers into a mold and allowing the molten materials to cool. The molding provides an article that is substantially a tube with an open end and a closed end encompassing a hollow volume. The open end provides the neck of the bottle and the closed end provides the base of the bottle after subsequent blow molding. The molding may be such that various flanges and protrusions at the open end provide strengthening ribs and/or closure means, for example screw threads for a cap. For a multilayer preform molding, the molten materials may be injected into the mold from an annular die such that they form a laminar flow of concentric layers. The molten materials are introduced into the mold such that the material for the outside trimodal ionomer layer and the inside layer enter the mold cavity before the material for the inner layer(s) enters and form a leading edge of the laminar flow through the cavity. For a period of time, the layers enter the mold cavity in a layered concentric laminar flow. Next, flow of the material for the inner layer(s) is halted and the material for the outside and inside layers provides a trailing edge of the laminar flow. The flow continues until the entire cavity is filled and the trailing edge seals or fuses to itself to form the closed end of the preform.

To prepare a bottle, the preform may be reheated and biaxially expanded by simultaneous axial stretching and blowing in a shaped mold so that it assumes the desired shape. The neck region is not affected by the blow molding operation while the bottom and particularly the walls of the preform are stretched and thinned.

Other examples of molded articles include injection molded or compression molded caps or closures for containers. Most containers have closures or caps to adequately seal the contents of a container against leakage from or into the container. In many instances, the cap is designed for repeated removal and replacement as the consumer accesses the contents of the container. A surface layer of the ionomer composition provides a soft feel for such caps and closures.

Closures or caps may be prepared by injection molding or compression molding. A cap may consist of a top and a depending skirt that close around the neck of the container. Caps may comprise continuous or discontinuous threads that provide screw closures to the container and/or snap closures. They may also incorporate dispensing features, tamper-evidence features and child resistant features. Other decorative or functional features may also be present. They may also include combinations with other materials (e.g., caps having metal lid portions or portions utilizing plastic materials other than a trimodal ionomer). Linerless caps may be molded from a trimodal ionomer composition. Alternatively, caps may have a separate liner that is inserted into the shell of the cap. A liner may be compression molded into the shell of the cap. Other closures include plastic stoppers or “corks” that are inserted into the opening of a container such as a wine bottle or perfume bottle.

The compositions may also be shaped by profile extrusion. A profile is defined by having a particular shape and by its process of manufacture is known as profile extrusion. A profile is not film or sheeting, and thus the process for making profiles does not include the use of calendering or chill rolls, nor is it prepared by injection molding processes. A profile is fabricated by melt extrusion processes that begin by (co)extruding a thermoplastic melt through an orifice of a die (annular die with a mandrel) forming an extrudate capable of maintaining a desired shape. The extrudate is typically drawn into its final dimensions while maintaining the desired shape and then quenched in air or a water bath to set the shape, thereby producing a profile. In the formation of simple profiles, the extrudate preferably maintains shape without any structural assistance. A common shape of a profile is tubing or hoses. Monolayer or multilayer tubing may be prepared. Tubing with an outer surface of the scuff-resistant composition described herein is preferred.

Films and powders comprising the scuff resistant trimodal ionomer composition may be prepared and used according to methods described in US Patent Application Publication 2009/0130355. These methods are useful in preparing articles with a surface layer of the trimodal ionomer composition, such as fabrics (woven or nonwoven) coated with the trimodal ionomer composition.

### EXAMPLES

The following Examples are provided to describe the invention in further detail. These Examples, which set forth a preferred mode presently contemplated for carrying out the invention, are intended to illustrate and not to limit the invention.

Bimodal ionomer compositions in Table 1 were prepared on a single screw or 28-mm twin screw extruder by blending the indicated materials and neutralizing to the indicated level using ZnO and/or zinc acetate neutralizing agents. The abbreviations used in these Examples for high molecular weight copolymers are identified in Table A, those for low molecular weight copolymers in Table B, and those for ionomers in Table C, above.

TABLE 1
Bimodal ionomers

| | High Mw | Low Mw | Nominal | |
|---|---|---|---|---|
| | Copolymer | copolymer | Neutralization | MI |
| | (weight %) | (weight %) | Level (%) | (g/10 min) |
| BMI-1 | HC-3 (90) | LC-2 (10) | 67% | 4.1 |
| BMI-2 | HC-1 (90) | LC-2 (10) | 34% | 4.5 |

BMI-1 was prepared using a one-step process in which HC-3, LC-2, zinc acetate dihydrate and zinc oxide were all fed in the rear feed hopper of a twin-screw extruder. A blend of 87.2 weight % of HC-1 and 9.7 weight % LC-2 (90:10 blend ratio) was neutralized on a single screw extruder with 3.1 weight % of a masterbatch concentrate of 55 weight % of HC-10 and 45 weight % ZnO to prepare BMI-2. After melt-mixing in the extruder, the compositions were strand-cut into pellets.

Pellets of the BMI-1 or BMI-2 and additional ionomers, as identified in Table C, were fed into an extruder and melt blended using conventional techniques. The resulting compositions were strand-cut into pellets and/or processed into articles for testing their properties. The example compositions are summarized in Table 2. Comparative Examples have a “C”-prefix. Comparative Examples C3 and C3A have the same nominal composition and were prepared at different times. Some variation in properties was observed between the two lots.

TABLE 2

| Example | BMI-1 | I-15 | I-16) | I-9 | I-13 | BMI-2 |
|---|---|---|---|---|---|---|
| C1 | 50 | 50 | 0 | 0 | 0 | 0 |
| C2 | 35 | 65 | 0 | 0 | 0 | 0 |
| 1 | 65 | 35 | 0 | 0 | 0 | 0 |
| 2 | 65 | 0 | 35 | 0 | 0 | 0 |
| 3 | 50 | 0 | 50 | 0 | 0 | 0 |
| 4 | 35 | 0 | 65 | 0 | 0 | 0 |
| C3 | 50 | 0 | 0 | 50 | 0 | 0 |
| C3A | 50 | 0 | 0 | 50 | 0 | 0 |
| C4 | 0 | 0 | 100 | 0 | 0 | 0 |
| C5 (BMI-1) | 100 | 0 | 0 | 0 | 0 | 0 |
| C6 | 75 | 0 | 0 | 0 | 25 | 0 |
| C7 | 50 | 0 | 0 | 0 | 50 | 0 |
| C8 | 25 | 0 | 0 | 0 | 75 | 0 |
| 5 | 0 | 0 | 80 | 0 | 0 | 20 |
| 6 | 0 | 0 | 65 | 0 | 0 | 35 |
| 7 | 0 | 0 | 50 | 0 | 0 | 50 |
| 8 | 0 | 0 | 35 | 0 | 0 | 65 |
| 9 | 0 | 0 | 20 | 0 | 0 | 80 |
| C9 (BMI-2) | 0 | 0 | 0 | 0 | 0 | 100 |

### Testing Criteria for Examples

Melt Index (MI) was measured in accord with ASTM D-1238, condition E, at 190° C., using a 2160-gram weight, with values of MI reported in grams/10 minutes. The melt indices of the compositions are summarized in Table 3.

The compositions were injection molded into standard flex bars and Shore D hardness was determined in accord with ASTM D-2240-05. Flex modulus was determined according to ASTM D-790-07 (Method B). These results are also summarized in Table 3.

TABLE 3

| | | | Injection molded flex bars | |
|---|---|---|---|---|
| | | Moisture | Shore D | Flex Modulus, |
| Example | MI | (ppm) | Hardness | (kpsi) |
| C1 | 4.2 | na | 48 | 20 |
| C2 | 2.4 | na | 51 | 26.9 |
| 1 | 7 | na | 40 | 13.3 |
| 2 | 5.8 | na | 39 | 12.4 |
| 3 | 3.9 | na | 43 | 18.8 |
| 4 | 1.7 | na | 49 | 25.6 |
| C3 | 2.6 | na | 43 | 20.6 |
| C3A | 2.6 | na | 43 | 20.6 |
| C4 | 1.1 (lit) | 600 | 59-65 | 53.1 |
| C5 (BMI-1) | 4.1 | na | 23.5 | 4.2 |
| C6 | na | na | 31.5 | 8.4 |
| C7 | na | na | 43.5 | 26.0 |
| C8 | na | na | 53.1 | 47.4 |
| 5 | 1.8 | 681 | 54 | 35.4 |
| 6 | 2.3 | 844 | 51 | 26.3 |
| 7 | 3.1 | 898 | 47 | 18.9 |
| 8 | 4 | 995 | 42 | 13.5 |
| 9 | 5 | 1084 | 38 | 9.5 |
| C9 (BMI-2) | 4.5 (lit) | na | 34 | 7.2 |

The compositions were injection molded into spheres about the size of a golf ball core (approximately 1.55 inches in diameter). The Shore D hardness, Atti (or PGA) compression and COR of the spheres were determined by the methods described below, and the results are summarized in Table 4.

As described above material hardness was measured according to the procedure set forth in ASTM-D2240-05. In that method, the hardness of a flat plaque formed of a bulk material is measured. Alternatively, the hardness of spheres formed from a bulk material was measured using a Portable Digital Durometer Hardness Tester, Shore Model 51, available from the Instron Corporation of Norwood, Mass. A Durotronic data collection equipment, Model 2000, also available from the Instron Corporation, was interfaced with the tester for data collection and calculation. One of ordinary skill in the art understands that there is a difference between the hardness of a bulk material (“material hardness”) measured on plaques and the hardness of a material, as measured directly on a spherical surface such as a golf ball. It is further understood that these two measurement techniques, when used on plaques and spheres of the same bulk material, may provide results that are different or that are not linearly related. Therefore, hardness values obtained by these two different techniques cannot be substituted, nor can they easily be correlated.

Atti Compression (also known as PGA Compression) is defined as the resistance to deformation of a golf ball, measured using an Atti Compression Gauge. The Atti Compression Gauge is designed to measure the resistance to deformation or resistance to compression of golf balls that are 1.680 inches in diameter. In these examples, smaller spheres of approximately 1.55 inches in diameter were used. Spacers or shims were used to compensate for this difference in diameter. The sphere diameters were measured. A shim thickness was calculated such that the sphere diameter plus shim thickness equaled 1.680 inches. Then the PGA compression of the sphere and shim was measured. A set of shims of different thicknesses was used to correct the sphere diameter plus shim thickness to within 0.0025 inches of 1.680 inches. After the PGA compression measurement was made, the value was mathematically corrected to compensate for any deviation from 1.680 inches. If the sphere diameter plus shim thickness was less than 1.680 inches, one compression unit was added for every 0.001 inch less than 1.680 inches. If the sphere diameter plus shim thickness was greater than 1.680 inches, one compression unit was subtracted for every 0.001 inch greater than 1.680 inches.

Coefficient of Restitution (COR) was measured by firing an injection-molded neat sphere of the resin having the size of a golf ball from an air cannon at several velocities over a range of roughly 60 to 180 fps. The spheres struck a steel plate positioned three feet away from the point where initial velocity is determined, and rebounded through a speed-monitoring device located at the same point as the initial velocity measurement. The COR of each measurement was determined as the ratio of rebound velocity to initial velocity. The individually determined COR measurements were plotted as a function of initial velocity. COR for a given initial velocity (i.e. COR-125 at 125 fps) was determined by linear regression.

Compositions of trimodal ionomers as described herein provide Atti compression from about 80 to about 160, preferably from about 90 to 130, and COR-125 from about 0.5 to about 0.65, preferably from about 0.54 to about 0.65.

TABLE 4
Neat Sphere Property

| | Shore D | Atti Com- | | | |
|---|---|---|---|---|---|
| Example | Hardness | pression | COR-125 | COR-150 | COR-180 |
| C1 | 49.7 | 116 | 0.668 | na | na |
| C2 | 54.7 | 130 | 0.678 | na | na |
| 1 | 42.5 | 96 | 0.64 | na | na |
| 2 | 41.8 | 93 | 0.621 | na | na |
| 3 | 48 | 116 | 0.619 | na | na |
| 4 | 53.9 | 127 | 0.626 | na | na |
| C3 | 48.9 | 115 | 0.635 | na | na |
| C3A | 47.1 | 119 | 0.633 | 0.610 | 0.583 |
| C4 | 64.9 | 154 | 0.625 | 0.603 | 0.577 |
| C5 (BMI-1) | 29 | 35 | 0.596 | 0.575 | 0.55 |
| C6 | 37.9 | 73 | 0.611 | 0.586 | 0.555 |
| C7 | 49.5 | 124 | 0.683 | 0.611 | 0.634 |
| C8 | 58.2 | 152 | 0.732 | 0.710 | 0.683 |
| 5 | 59.6 | 119 | 0.603 | 0.581 | 0.555 |
| 6 | 56.5 | 127 | 0.585 | 0.565 | 0.54 |
| 7 | 51.9 | 117 | 0.567 | 0.546 | 0.521 |
| 8 | 49.8 | 98 | 0.547 | 0.527 | 0.502 |
| 9 | 44.7 | 80 | 0.525 | 0.505 | 0.481 |
| C9 (BMI-2) | 41.6 | 59 | 0.503 | 0.484 | 0.461 |

The scuff resistance of the covers of a series of two-piece golf balls was measured. First, two-piece golf balls were prepared by injection molding cores of a composition comprising 65 weight % of HC-4 and 35 wt % oleic acid, wherein 94 to 100% of the total carboxylic acid groups were neutralized to form magnesium carboxylate salts. The density of the core material was adjusted to 1.15 g/cc (36.8 g/1.55 inch diameter sphere) by adding BaSO₄. to the composition prior to injection molding. The cores were 1.55 inches in diameter. Cover layers were deposited over the cores, also by injection molding, to provide two-piece balls with nominal diameter of 1.68 inches.

The two-piece golf balls were weighed, and their scuff damage weight loss was determined in the following manner: a D-2 tool steel plate machined to simulate a sharp grooved pitching wedge with square grooves was mounted on a swing arm that swings in a horizontal plane. The simulated club face was oriented for a hit on a golf ball at a 60° angle between the simulated club face and tangent to point of impact on sphere. The machine was operated at a club head speed of 110 feet per second. Each ball was hit once; however, at least three balls of each cover composition were tested. The golf balls were re-weighed. Scuff damage was reported as the average amount of material removed from the golf balls by the simulated club face.

TABLE 5

| | Scuff weight |
|---|---|
| Example | loss (mg/hit) |
| C1 | 14.7 |
| C2 | 18.3 |
| 1 | 4.5 |
| 2 | 1.3 |
| 3 | 2.1 |
| 4 | 4.2 |
| C3 | 11.7 |
| C3A | 6.5 |
| C4 | 4.8 |
| C5 (BMI-1) | 0.5 |
| C6 | 1.6 |
| C7 | 18.6 |
| C8 | 18.3 |
| 5 | 2.9 |
| 6 | 1.6 |
| 7 | 1.4 |
| 8 | 2.4 |
| 9 | 2.4 |
| C9 (BMI-2) | 1.3 |

Bimodal ionomers BMI-1 (Comparative Example C5) and BMI-2 (Comparative Example C9) had excellent scuff resistance. Their Shore D hardness and flex modulus, however, indicate that they are too soft for many applications, including covers for golf balls. When a zinc-neutralized ethylene acid dipolymer with 15 weight % of methacrylic acid was added to BMI-1 (Comparative Examples C3 and C3A), the material's hardness and flex modulus were improved; however, the scuff weight loss became unacceptable. Surprisingly, when an additional ionomer based on a low-acid (less than 12 weight %) E/W dipolymer is added to either bimodal ionomer BMI-1 or BMI-2, the resulting trimodal ionomer retains good scuff resistance while providing adequate values of hardness and flex modulus for use as a golf ball cover material.

While certain of the preferred embodiments of this invention have been described and specifically exemplified above, it is not intended that the invention be limited to such embodiments. Various modifications may be made without departing from the scope and spirit of the invention, as set forth in the following claims.

What is claimed is:

1. A composition comprising:
(a) 15 to 80 weight %, based on the combination of (a), (b) and (c), of an E/X/Y terpolymer, wherein E represents copolymerized units of ethylene, X represents copolymerized units of a C₃ to C₈ α,β-ethylenically unsaturated carboxylic acid, and Y represents copolymerized units of a softening comonomer selected from the group consisting of vinyl acetate, alkyl acrylate and alkyl methacrylate; wherein the alkyl groups have from 1 to 8 carbon atoms; wherein the amount of X is from about 2 to about 30 weight % of the E/X/Y terpolymer and the amount of Y is from about 3 to about 45 weight % of the E/X/Y terpolymer; and wherein the weight average molecular weight (Mw) of the E/X/Y terpolymer is in the range of 80,000 to 500,000 Da;
(b) 5 to 80 weight %, based on the combination of (a), (b) and (c), of an E/W dipolymer, wherein E represents copolymerized units of ethylene and W represents copolymerized units of acrylic acid or methacrylic acid; wherein the amount of W is about 3 to about 12 weight % of the E/W dipolymer; and wherein the Mw of the E/W dipolymer is in the range of 80,000 to 500,000 Da; and
(c) 2 to 20 weight %, based on the combination of (a), (b) and (c), of an E/Z dipolymer, wherein E represents copolymerized units of ethylene and Z represents copolymerized units of acrylic acid or methacrylic acid; wherein the amount of Z is about 3 to about 25 weight % of the E/Z copolymer; and wherein the Mw of the E/Z dipolymer in the range of 2,000 to 30,000 Da; and
wherein at least 70% of the combined carboxylic acid groups in the E/X/Y terpolymer, the E/W dipolymer and the E/Z dipolymer are nominally neutralized to carboxylate salts comprising a preponderance of zinc cations.

2. The composition of claim 1 having a Shore D hardness of 35 to 55 determined according to ASTM D-2240 using molded standard flex bars and a flex modulus of 9 to 50 kpsi determined according to ASTM D-790B using molded standard flex bars.

3. The composition of claim 1 wherein X represents copolymerized units of acrylic acid or methacrylic acid; wherein the amount of X is from 5 to 20 weight % of the E/X/Y copolymer; wherein Y represents copolymerized units of an alkyl acrylate; and wherein the amount of Y is from 10 to 45 weight % of the E/X/Y copolymer.

4. The composition of claim 1 wherein Y represents copolymerized units of n-butyl acrylate.

5. The composition of claim 4 wherein X represents copolymerized units of acrylic acid.

6. The composition of claim 4 wherein X represents copolymerized units of methacrylic acid.

7. The composition of claim 1 wherein W represents copolymerized units of methacrylic acid.

8. The composition of claim 1, having a scuff damage weight loss of less than 5 mg.

9. A method for increasing the hardness and flex modulus and retaining scuff resistance of a first ionomer composition, the method comprising melt mixing the first ionomer composition with a second ionomer composition;
wherein the first ionomer composition comprises
(i) 70 to 95 weight %, based on the total weight of (i) and (ii), of an E/X/Y terpolymer, wherein E represents copolymerized units of ethylene, X represents copolymerized units of a C₃ to C₈ α,β-ethylenically unsaturated carboxylic acid, and Y represents copolymerized units of a softening comonomer selected from the group consisting of vinyl acetate, alkyl acrylate and alkyl methacrylate; wherein the alkyl groups have from 1 to 8 carbon atoms; wherein the amount of X is from about 2 to about 30 weight % of the E/X/Y terpolymer, and the amount of Y is from 3 to about 45 weight % of the E/X/Y terpolymer; and wherein the weight average molecular weight (Mw) of the E/X/Y terpolymer is in the range of 80,000 to 500,000 Da; and
(ii) 5 to 30 weight %, based on the total weight of (i) and (ii), of an E/Z copolymer, wherein E represents copolymerized units of ethylene and Z represents copolymerized units of acrylic acid or methacrylic acid; wherein the amount of Z is about 3 to about 25 weight % of the E/Z copolymer; and wherein the Mw of the E/Z copolymer is in the range of 2,000 to 30,000 Da; and
wherein at least 30% of the combined carboxylic acid groups in the E/X/Y terpolymer and the E/Z copolymer are nominally neutralized to form zinc carboxylate salts; and
wherein the second ionomer composition comprises an E/W dipolymer, wherein E represents copolymerized units of ethylene and W represents copolymerized units of acrylic acid or methacrylic acid; wherein the amount of W is about 2 to about 12 weight % of the E/W dipolymer; wherein the Mw of the E/W dipolymer is in the range of 80,000 to 500,000 Da; and wherein at least 35% of the carboxylic acid groups in the E/W dipolymer are nominally neutralized to form zinc carboxylate salts;
to provide a third ionomer composition comprising 5 to 80 weight % of the second ionomer composition, based on the total weight of (i), (ii) and the second ionomer composition, wherein the third ionomer composition has Shore D hardness of 35 to 55, flex modulus of 9 to 50 kpsi and a scuff damage weight loss of less than 5 mg.

10. The method of claim 9 wherein X represents copolymerized units of acrylic acid or methacrylic acid and the amount of X is from 5 to 20 weight % of the E/X/Y copolymer; and wherein Y represents copolymerized units of an alkyl acrylate and the amount of Y is from 10 to 45 weight % of the E/X/Y copolymer.

11. The method of claim 9 wherein Y represents copolymerized units of n-butyl acrylate.

12. The method of claim 10 wherein X represents copolymerized units of acrylic acid.

13. The method of claim 10 wherein X represents copolymerized units of methacrylic acid.

14. The method of claim 9 wherein W represents copolymerized units of methacrylic acid.

15. The method of claim 9 further comprising the steps of processing the third ionomer composition in a molten state into a shaped third ionomer composition; and allowing the shaped third ionomer composition to cool to provide a shaped article comprising the third ionomer composition.

16. The method of claim 15 wherein the processing comprises one or more methods selected from the group consisting of extrusion, injection molding, compression molding, overmolding, profile extrusion, lamination, coextrusion, and extrusion coating.

17. The method of claim 16 wherein the shaped article is a film, a sheet, tubing, or a molded article.

18. The method of claim 17 wherein the shaped article is a one piece golf ball or is a golf ball comprising a cover, a core and optionally at least one intermediate layer between the cover and the core, wherein at least one of the cover, core or intermediate layer comprises the third ionomer composition.

19. The method of claim 18 wherein the shaped article is a golf ball comprising a cover, a core and optionally at least one intermediate layer between the cover and the core, wherein the cover comprises the third ionomer composition.

20. An article comprising the composition of claim 1.

21. The article of claim 20 that is a film, a sheet, tubing, or a molded article.

22. The article of claim 21 wherein the article is a one piece golf ball or is a golf ball comprising a cover, a core and optionally at least one intermediate layer between the cover and the core, wherein at least one of the cover, core or intermediate layer comprises the composition.

23. The article of claim 22 wherein the shaped article is a golf ball comprising a cover, a core and optionally at least one intermediate layer between the cover and the core, wherein the cover comprises the composition.
